(19) United States
(12) Patent Application Publication
(10) Pub. No.: US 2026/0161468 A1
(43) Pub. Date: Jun. 11, 2026

(54) RESOURCE REQUEST VALUE GENERATION

(71) Applicant: HEWLETT PACKARD ENTERPRISE DEVELOPMENT LP, Spring, TX (US)

(72) Inventors: Kevin James Johnson, Mississauga (CA); Pradeepkumar Vijayakumar, San Jose, CA (US)

(21) Appl. No.: 18/973,270

(22) Filed: Dec. 9, 2024

(51) Int. Cl. G06F 9/50

(52) U.S. Cl. CPC G06F 9/5033

(57) ABSTRACT

In some examples, a system computes, based on metric information of a computing environment, a lower bound and an upper bound of resource usage in the computing environment. Based on the lower bound and the upper bound, the system derives a plurality of candidate resource request values. For each respective candidate resource request value, the system computes a corresponding score representing a sufficiency of the respective candidate resource request value and resource waste associated with the respective candidate resource request value. Based on the scores, the system elects a resource request value from the plurality of candidate resource request values. The system provides the selected resource request value to a service for inclusion in a scheduling request to schedule a workload of the service in the computing environment.

### BACKGROUND

Services can be executed in compute nodes. A compute node includes various resources that can be used by a service during execution of the service. The resources can include processing resources, memory resources, communication resources, or other types of resources.

### BRIEF DESCRIPTION OF THE DRAWINGS

Some implementations of the present disclosure are described with respect to the following figures.

FIG. 1 is a block diagram of an arrangement that includes a resource request value generator for generating resource request values for use by services in generating scheduling requests sent to a scheduler for deploying workloads across compute nodes, in accordance with some examples.

FIG. 2 is a graph depicting a time series of actual resource usage values over time, according to some examples.

FIG. 3 is a flow diagram of a resource request value generation process, according to some examples.

FIG. 4 is a graph depicting scores computed for different days, according to some examples.

FIG. 5 is a block diagram of a storage medium storing machine-readable instructions according to some examples.

FIG. 6 is a block diagram of a system according to some examples.

FIG. 7 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A scheduler can schedule services across compute nodes of a computing environment based on requests from services. The scheduler receives scheduling requests, and based on the scheduling requests, the scheduler assigns workloads associated with the scheduling requests to selected computing nodes of the computing environment. A scheduling request may include a resource request value that specifies an amount of resources to be used by a service when a workload for the service executes in the computing environment. The resource request value can specify any or some combination of the following resources: processing resources, memory resources, communication resources, or other types of resources. For example, the resource request value can specify any or some combination of the following: a quantity of processing cores to be used, a size of memory to be used, or a communication bandwidth to be used. The resource request value included in the scheduling request by the service can be retrieved by the service from configuration information (e.g., a configuration file or any other configuration object) associated with the service. The resource request value can be set in the configuration information by a human administrator, a program, or a machine.

Based on the resource request value in a scheduling request from the service, the scheduler can schedule execution of the workload for the service on a selected compute node of multiple compute nodes. For example, the scheduler can determine the amount of resources available in each of the multiple compute nodes, and based on this determination, the scheduler can pick the compute node with sufficient resources to meet a target resource usage represented by the resource request value. In some cases, the resource request value included in the scheduling request may be suboptimal. For example, a low resource request value indicates that the target resource usage of the service is expected to be relatively low, but the actual resource consumption by the service when deployed on a compute node is higher than the target resource usage represented by the resource request value. In this scenario, execution of the workload of the service in the compute node that consumes more resources than expected may cause resource contention issues with workloads of other services executing in the compute node. The resource contention may lead to poor performance of one or more services in the compute node.

As another example, a high resource request value indicates that the target resource usage of the service is expected to be relatively high. In response to the high resource request value, the scheduler may schedule the workload of the service on a compute node with a larger amount of available resources. However, if the actual resource consumption by the service when deployed on the compute node is lower than the target resource usage represented by the resource request value, that can lead to resource waste since the workload of the service is placed on a compute node with excess resources that may not be used. Since a portion of the resources of the compute node have been consumed by the service, the compute node may not be available for another service that submits a request with a high resource request value.

In accordance with some implementations of the present disclosure, techniques or mechanisms produce an optimized resource request value to be used by a service when issuing a scheduling request to a scheduler to deploy the service in an arrangement of compute nodes of a computing environment. An “optimized” resource request value is calculated based on collected metric information of the service (or multiple services) in the computing environment, where the resource request value seeks to provide a balance between meeting a resource demand of the service and reducing resource waste due to a resource usage represented by the selected candidate resource request value. In some examples, a system computes, based on the collected metric information in the computing environment, a lower bound and an upper bound of resource usage in the computing environment. Based on the lower bound and the upper bound, the system derives multiple candidate resource request values. For each respective candidate resource request value of the multiple candidate resource request values, the system computes a corresponding score representing a sufficiency of the respective candidate resource request value and a resource waste associated with the respective candidate resource request value. Based on the scores, the system selects a resource request value from the plurality of candidate resource request values. The system provides the selected resource request value to the service for inclusion in a scheduling request by the service in the computing environment.

In some examples, a resource request value can specify the minimum amount of resources that a service is to be allocated for the service to run properly. In an example, a computing environment can include a Kubernetes cluster, which is a cluster of compute nodes on which containers (or mores specifically, pods) can execute. A pod includes one or more containers. Kubernetes allows resource constraints to be specified, with one example resource constraint being a resource request value representing the minimum amount of resources for a pod. In other examples, the resource request value can specify another target amount of resources (different from the minimum amount of resources) to be used by a service. For example, the resource request value can specify an average or mean amount of resources to be used by a service.

Resource request values produced by techniques or mechanisms according to some examples of the present disclosure for use in scheduling requests by services can improve computer functionality by allowing services to be deployed on compute nodes with available resources that can meet expected resource demands of the services while avoiding wasting resources of the compute nodes.

A “service” can refer to any entity that can request that a workload be run in a computing environment. The service may include a program, a micro-service, or any other type of executable entity. A “workload” can refer to a collection of activities performed in the computing environment. A “scheduling request” can refer to any information sent from a service to a scheduler requesting that a workload be deployed in a compute node for execution.

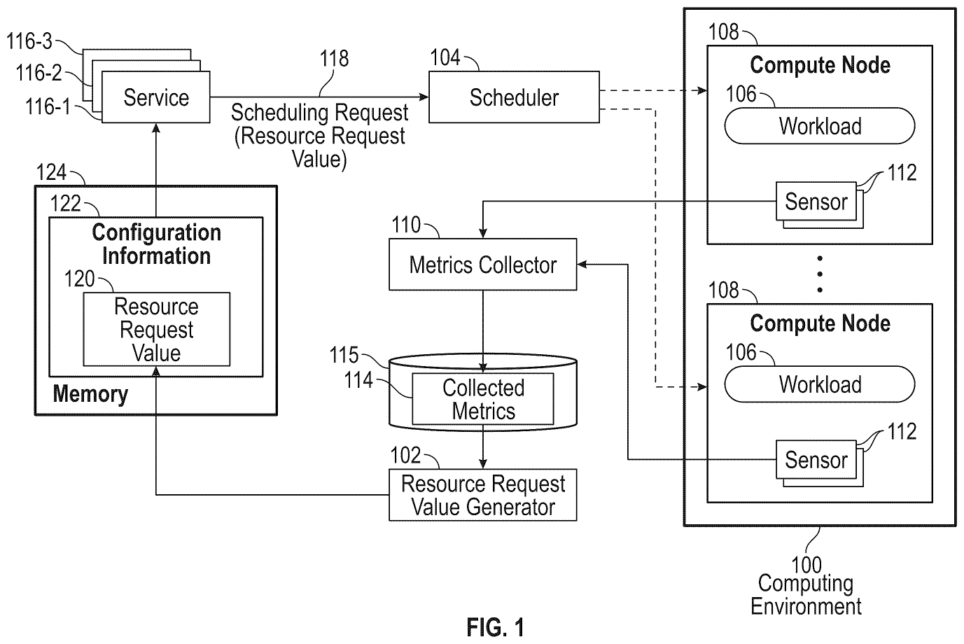

FIG. 1 is a block diagram of an example arrangement that includes a resource request value generator 102 according to some examples of the present disclosure. The arrangement also includes a scheduler 104 to schedule workloads 106 across compute nodes 108 in a computing environment 100. The compute nodes 108 can form a cluster of compute nodes, such as in a Kubernetes cluster. In other examples, the arrangement of compute nodes 108 can be according to other technologies. More generally, the compute nodes 108 are part of a computing environment, such as a data center, a cloud computing environment, or another type of computing environment. A compute node 108 can include a computer or a portion of the computer, such as a processor, a collection of processors, or any other processing resource on which workloads can be executed.

A metrics collector 110 collects metrics provided by sensors 112 associated with the compute nodes 108. The metrics are associated with execution of workloads in the compute nodes 108.

The resource request value generator 102, the scheduler 104, and the metrics collector 110 can be implemented using machine-readable instructions executed on the same computer system or on different computer systems. A computer system can include one or more computers. Although the resource request value generator 102, the scheduler 104, and the metrics collector 110 are depicted as being external of the computing environment 100, in other examples, any one or more of the resource request value generator 102, the scheduler 104, or the metrics collector 110 can be part of the computing environment 100.

The sensors 112 may be inside or outside the compute nodes 108, or both inside and outside the compute nodes 108. A “sensor” can refer to a hardware sensor or a sensor implemented using machine-readable instructions. Examples of metrics acquired by the sensors 112 include any or some combination of the following: utilization of processing resources, utilization of memory resources, utilization of communication resources, and/or other metrics. The sensors 112 provide the acquired metrics to the metrics collector 110.

The metrics collector 110 stores collected metrics 114 in a data store 115. The data store 115 can be implemented using one or more storage devices. The collected metrics 114 can span a specified time interval (e.g., a time interval including a number of minutes, a number of hours, a number of days, a number of weeks, a number of years, etc.).

The scheduler 104 receives scheduling requests from services 116-1, 116-2, and 116-3 (note that a different quantity of services may be present in other examples). Based on the scheduling requests from the services 116-1, 116-2, and 116-3, the scheduler 104 can select compute nodes 108 on which workloads 106 of the services 116-1, 116-2, and 116-3 are to be deployed.

A scheduling request 118 from the service 116-1 contains a resource request value 120 that is extracted from configuration information 122 associated with the service 116-1. The resource request value 120 represents a target resource usage, such as a minimum expected resource usage of the service 116-1 or another expected resource usage of the service 116-1.

The configuration information 122 can be stored in a memory 124 accessible by the service 116. Each of the services 116-1, 116-2, and 116-3 can be associated with a respective configuration information that contains a corresponding resource request value. The memory 124 can be part of a computer on which the service 116-1 is deployed.

The resource request value generator 102 can write the resource request value 120 to the configuration information 122. The resource request value 120 is generated by the resource request value generator 102 based on the collected metrics 114. The resource request value 120 computed by the resource request value generator 102 provides a balance between meeting a resource demand of the service 116-1 and reducing resource waste due to the target resource usage represented by the resource request value 120.

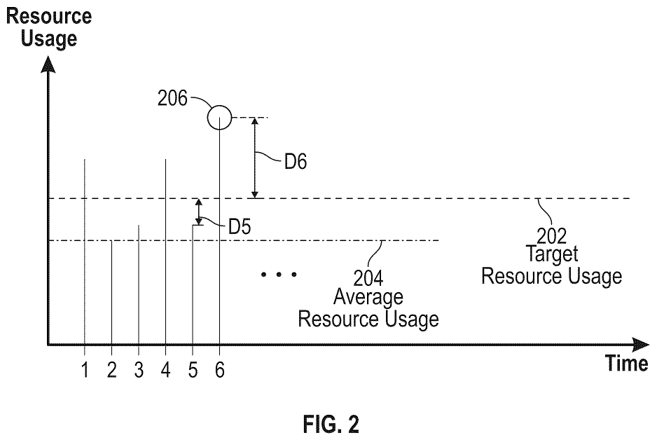

In some examples, whether a resource request value meets a demand of a service can be represented by a time score that indicates the relative amount of time that actual resource usage is above a target resource usage represented by the resource request value. FIG. 2 is a graph of a time series including actual resource usage values (vertical axis of the graph) at respective time points (horizontal axis of the graph). Vertical lines at respective time points 1, 2, 3, and so forth, represent respective actual resource usage values at the corresponding time points. The actual resource usage values represent usage of one or more resources (e.g., a processing resource, a memory resource, a communication resource, etc.) by a service.

The upper horizontal dashed line in FIG. 2 represents a target resource usage 202 represented by a resource request value. Different resource request values represent different target resource usage values. As shown in FIG. 2, the actual resource usage may be above the target resource usage 202 at some time points, and below the target resource usage 202 at other time points.

In some examples, a higher time score indicates that the actual resource usage of the service is above the target resource usage at a greater quantity of time points. A lower time score indicates that the actual resource usage of the service is above the target resource usage at fewer time points. Thus, in such examples, a lower time score is more desirable than a higher time score, since the lower time score indicates that the resource request value is meeting the demand of the service more often than not. In some examples, the time score can be expressed as a percentage value representing the percentage of time that the actual resource usage of the service is above the target resource usage.

Waste due to the target resource usage represented by the resource request value can be represented by a deviation score that represents an average deviation of the actual resource usage of the service from the target resource usage represented by the resource request value. For example, a deviation D6 represents an absolute difference between the actual resource usage at time point 6 and the target resource usage 202. A deviation D5 represents an absolute difference between the actual resource usage at time point 5 and the target resource usage 202. Note that although the actual resource usage at time point 6 is above the target resource usage 202 and the actual resource usage at time point 5 is below the target resource usage 202, the deviations D6 and D5 are both positive values since they represent absolute differences. The deviation score is computed by calculating an average (or some other mathematical aggregate such as sum, mean, etc.) of the deviations at respective time points. A lower deviation score indicates that the average deviation (or another aggregated deviation) of actual resource usages with respect to the target resource usage 202 is lower than the average deviation (or another aggregated deviation) represented by a higher deviation score. A lower deviation score in such examples is indicative of less resource waste since the workload of the service is placed on a compute node with available resources that more closely matches the actual resource usage of the service. In some examples, the deviation score can be expressed as a percentage value representing the average deviation as a percentage of the target resource usage 202.

In other examples, other types of scores can be used for indicating whether a service's resource usage demand can be met given a resource request value and for indicating resource waste associated with the resource request value.

FIG. 2 further includes a lower horizontal dashed line representing an average resource usage 204 that is based on an average of the actual resource usage values in the time series of FIG. 2. As discussed further below, resource request values can be derived from the average resource usage 204.

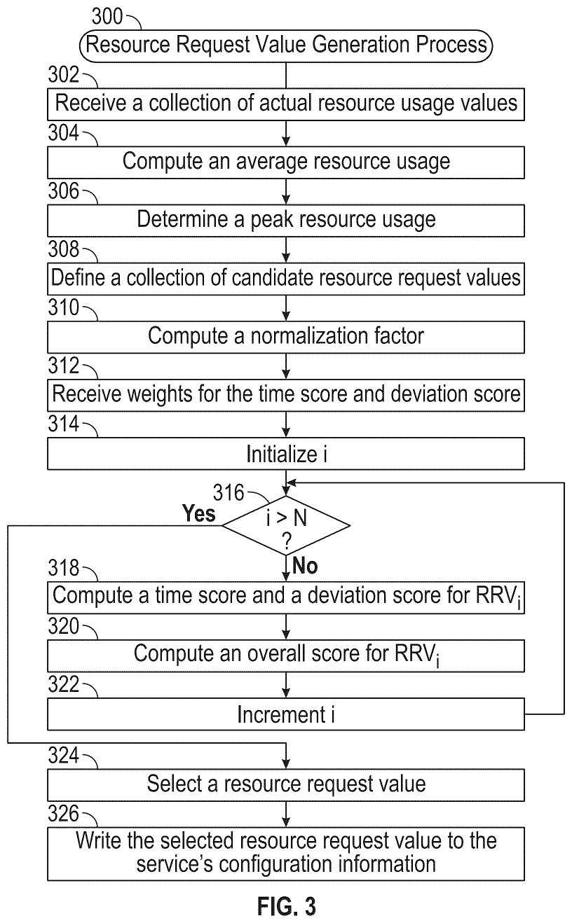

FIG. 3 is a flow diagram of a resource request value generation process 300 performed by the resource request value generator 102, in accordance with some examples of the present disclosure. The resource request value generator 102 receives (at 302) a collection of actual resource usage values, such as a time series of actual resource usage values over time (e.g., the time series shown in FIG. 2).

Based on the collection of actual resource usage values, the resource request value generator 102 computes (at 304) an average resource usage (e.g., 204 in FIG. 2) based on the actual resource usage values in the collection. The average can be based on actual resource usage values in a given time window of a specified length (the length may be configurable).

The resource request value generator 102 also determines (at 306) a peak resource usage (represented as 206 in FIG. 2, for example). The “peak” resource usage refers to the maximum resource usage value observed in the given time window.

In some examples, the average resource usage provides a lower bound on resource usage by a service, and the peak resource usage provides an upper bound on resource usage by the service. In other examples, instead of computing the average resource usage, another aggregate of resource usage values over a given time window can be computed. For example, the other aggregate can include a median of the resource usage values, or another mathematical function applied on resource usage values in the given time window.

The resource request value generator 102 defines (at 308) a collection of candidate resource request values between the lower bound and the upper bound. The collection of candidate resource request values includes a lowest candidate resource request value (e.g., set equal the lower bound), a highest candidate resource request value (e.g., set equal the upper bound), and intermediate candidate resource request values between the lowest candidate resource request value and the highest candidate resource request value. In an example, assuming the average resource usage is represented as Average_Usage, then a candidate resource request value can be expressed as CTV·Average_Usage, where CTV is a variable starts at a minimum value CTVₘᵢₙ (e.g., 1.0 or another low value) and ends at a maximum value CTVₘₐₓ. The maximum value CTVₘₐₓ is based on the peak resource usage (the peak resource usage is represented as Peak_Usage). In an example, the maximum value CTVₘₐₓ can be set based on

$$\frac{Peak\_Usage}{Avg\_Usage} .$$

Starting at CTVₘᵢₙ, CTV is incremented by an incremental step (Δ) to generate a collection of CTV values, e.g. {CTVₘᵢₙ, CTVₘᵢₙ+Δ, CTVₘᵢₙ+2Δ, CTVₘᵢₙ+3Δ, . . . , CTVₘₐₓ}. In a specific example, if CTVₘᵢₙ=1.0 and CTVₘₐₓ=3.0, and Δ=0.05, then the collection of CTV values is {1.0, 1.05, 1.10, 1.15, 1.20, 1.25, . . . , 3.0}. The collection of CTV values produces a respective collection of candidate resource request values {RRV₁, RRV₂, RRV₃, . . . , RRV_{N}}, where N represents the quantity of candidate resource request values in the collection:

$${RRV}_{1} = {CTV}_{min} \cdot Average\_Usage , \\ {RRV}_{2} = ( {CTV}_{min} + Δ ) \cdot Average\_Usage , \\ {RRV}_{3} = ( {CTV}_{min} + 2 Δ ) \cdot Average\_Usage , \\ … , \\ {RRV}_{N} = {CTV}_{max} \cdot Average\_Usage .$$

In the above example CTVₘᵢₙ can be expressed as CTV₁, CTVₘᵢₙ+Δ can be expressed as CTV₂, CTVₘᵢₙ+2Δ can be expressed as CTV₃, . . . , and CTVₘₐₓ can be expressed as CTV_{N}. The N CTV values are used to produce the N resource request values {RRV₁, RRV₂, RRV₃, . . . , RRV_{N}} according to CTVᵢ·Average_Usage.

The resource request value generator 102 selects a resource request value from the collection of candidate resource request values {RRV₁, RRV₂, RRV₃, . . . , RRV_{N}} to provide to a service, such as by writing the selected resource request value to the configuration information of the service (e.g., the configuration information 122 of the service 116-1). The selection of the resource request value is based on scores computed for the candidate resource request values.

As discussed above, the resource request value generator 102 computes a time score and a deviation score. The time score can indicate the relative amount of time that actual resource usage is above a target resource usage represented by a candidate resource request value. The deviation score can represent an average deviation of the actual resource usage of the service from the target resource usage represented by a candidate resource request value.

The resource request value generator 102 computes (at 310) a normalization factor NF to be applied to the time score and the deviation score. The normalization factor is used to normalize the time score and the deviation score such that they have an equal impact (or approximately equal impact) on an overall score computed for each candidate resource usage value. As noted further above, the time score and deviation score can be expressed as percentage values. If, based on historical metrics collected for the computing environment 100, a time score of 3% or lower is considered to be “good,” and a deviation score of 10% or lower is considered to be “good”, then equating the time score and the deviation score would normalize the 3% for the time score by multiplying by a normalization factor NF of 3.33, or alternatively, the deviation score can be normalize by multiplying by a normalization factor NF of 0.33.

The resource request value generator 102 also receives (at 312) weights for the time score and the deviation score. The time score weight Wₜᵢₘₑ and the deviation score weight W_{deviation} can be specified by a human, a program, or machine. The weights Wₜᵢₘₑ and W_{deviation} are set to indicate which of the time score and the deviation score has a greater impact on an overall score for a candidate resource request value.

The resource request value generator 102 initializes (at 314) a variable i to an initial value (e.g., 1). The resource request value generator 102 iterates through i (e.g., from 1 to N) to consider each candidate resource request value RRVᵢ of the collection of candidate resource request values {RRV₁, RRV₂, RRV₃, . . . , RRV_{N}}. More specifically, the resource request value generator 102 iterates through CTV₁, CTV₂, . . . , CTV_{N} and computes the corresponding candidate resource request values.

The resource request value generator 102 determines (at 316) whether i is greater than N. If so, all of the candidate resource request values have been considered, and the resource request value generator 102 can exit the iterative loop including tasks 316, 318, 320, and 322.

However, if i is not greater than N, the resource request value generator 102 computes (at 318) a time score Time_Score(i) and a deviation score Deviation_Score(i) for candidate resource request value RRVᵢ. The resource request value generator 102 also normalizes either Time_Score(i) or Deviation_Score(i) by the normalization factor NF.

Time_Score(i) can be the percentage of time points that the actual resource usage values are above the target resource usage represented by RRVᵢ. Deviation_Score (i) can be a value (e.g., expressed as a percentage as noted further above) derived from an average of the deviations at respective time points relative to the target resource usage represented by RRVᵢ.

The resource request value generator 102 computes (at 320) an overall score Overall_Score(i) for RRVᵢ as follows:

$$Overall\_Score ( i ) = {W}_{time} \cdot Time\_Score ( i ) + {W}_{deviation} \cdot Deviation\_Score ( i ) . \qquad ( Eq . 1 )$$

The resource request value generator 102 increments (at 322) i, and returns to task 314 to determine whether to perform another iteration. If i is greater than N, then the resource request value generator 102 exits the iterative loop.

Next, the resource request value generator 102 selects (at 324) a resource request value from the collection of candidate resource request values {RRV₁, RRV₂, RRV₃, . . . , RRV_{N}}. The selection is based on comparing the overall scores, Overall_Score(1), . . . , Overall_Score(N). In some examples where a lower score indicates a better performing resource request value, the selected resource request value is the candidate resource request value with the lowest overall score.

The resource request value generator 102 writes (at 326) the selected resource request value to the configuration information of the service for which the resource request value is selected. The service includes the resource request value written to the service's configuration information in scheduling requests sent to the scheduler 104, which uses the resource request value in deciding which compute node 108 the workload requested by the scheduling request is to be placed.

In some cases, metrics such as actual resource usage values may be collected over a large time window, such as over 30, 60, 90, or more days. The actual resource usage values may be collected at one-minute intervals, so there may be 1,440 actual resource usage values per day. Computing the time score and deviation score for each candidate resource request value over a large time window can be computationally expensive and make take a relatively long processing time.

In some examples of the present disclosure, rather than attempt to compute the time score and deviation score based on the large quantity of actual resource usage values collected over many days, the resource request value generator 102 can instead compute the time score and deviation score for each day individually, and then aggregate the time scores and deviation scores computed for the multiple days.

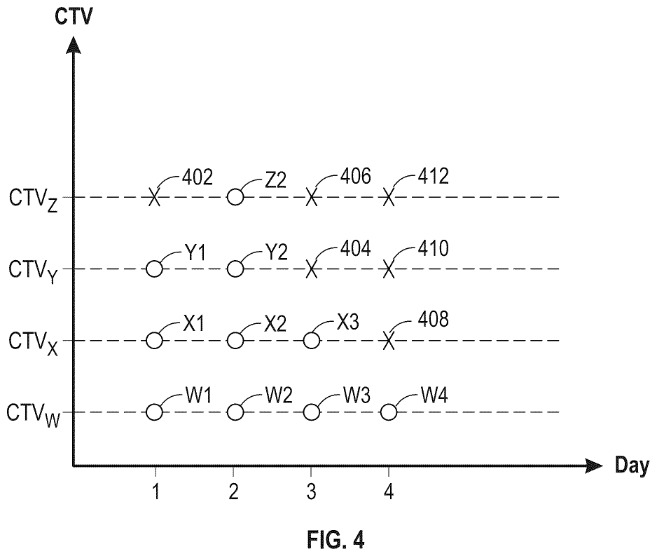

FIG. 4 shows an example of how a time score for each CTVᵢ (and thus a corresponding candidate resource request value RRVᵢ) can be computed over multiple days in a more computationally efficient manner. For simplicity, FIG. 4 assumes there are four CTV values: {CTV_{W}, CTV_{X}, CTV_{Y}, CTV_{Z}} represented by the vertical axis of the graph in FIG. 4, and four days 1, 2, 3, and 4 represented by the horizontal axis of the graph. It is assumed that CTV_{W}<CTV_{X}<CTV_{Y}<CTV_{Z}. In an example, CTV_{W} is set at 1.0 (or another low value), while CTV_{Z} is set at the maximum observed over days 1 to 4. Recall from above that CTVₘₐₓ can be set based on

$$\frac{Peak\_Usage}{Avg\_Usage}$$

Note that

$$\frac{Peak\_Usage}{Avg\_Usage}$$

may be different across the four days, since different actual resource usage values are collected across the four days. State differently,

$$\frac{Peak\_Usage}{Avg\_Usage}$$

for day p may be different from

$$\frac{Peak\_Usage}{Avg\_Usage}$$

for day q (p≈q).

Note that there will be a lot more CTV values (ranging from the lowest CTV_{W} value up to the maximum CTV_{Z} value) than the four CTV values shown in FIG. 4.

In each day, the resource request value generator 102 attempts to compute time scores for the respective CTV values in {CTV_{W}, CTV_{X}, CTV_{Y}, CTV_{Z}}. The computation of a time score in a given day is based on the actual resource usage values of the given day.

In day 1, the resource request value generator 102 calculates the time scores W1, X1, and Y1 for the CTV_{W}, CTV_{X}, and CTV_{Y} values, respectively. However, in the example, the resource request value generator 102 is unable to calculate the time score for the CTV_{Z} value, because the peak resource usage (Peak_Usage) in day 1 would not reach CTV_{Z}, i.e., the upper bound on the resource request value represented by CTV_{Z} exceeds the peak resource usage in day 1. An X 402 in FIG. 4 indicates that the resource request value generator 102 did not compute a time score for the CTV_{Z} value in day 1.

In day 2, the resource request value generator 102 calculates the time scores W2, X2, Y2, and Z2 for the CTV_{W}, CTV_{X}, CTV_{Y} and CTV_{Y} values, respectively. In day 2, the peak resource usage (Peak_Usage) does reach CTV_{Z}.

In day 3, the resource request value generator 102 calculates the time scores W3 and X3 for the CTV_{W} and CTV_{X} values, respectively. However, in the example, the resource request value generator 102 is unable to calculate the time scores for the CTV_{Y} and CTV_{Z} values in day 3, because the peak resource usage (Peak_Usage) in day 3 would not reach CTV_{Y}. An X 404 and an X 406 indicate that the resource request value generator 102 did not compute time scores for the CTV_{Y} and CTV_{Z} values in day 3.

In day 4, the resource request value generator 102 calculates the time score W4 for the CTV_{W} value. However, in the example, the resource request value generator 102 is unable to calculate the time scores for the CTV_{X}, CTV_{Y} and CTV_{Z} values in day 4, because the peak resource usage (Peak_Usage) in day 4 would not reach CTV_{X}. An X 408, an X 410, and an X 412 indicate that the resource request value generator 102 did not compute time scores for the CTV_{X}, CTV_{Y} and CTV_{Z} values in day 4.

The resource request value generator 102 then proceeds to aggregate the time scores for each CTV in FIG. 4. In some examples, a lack of a time score (represented by an X in FIG. 4) can be assigned the value 0. The resource request value generator 102 aggregates W1, W2, W3, and W4 (such as by dividing the sum of W1, W2, W3, and W4 by four days) to produce an aggregate time score for the candidate resource request value represented by CTV_{W}. The resource request value generator 102 aggregates X1, X2, X3, and 0 (such as by dividing the sum of X1, X2, X3, and 0 by four days) to produce an aggregate time score for the candidate resource request value represented by CTV_{X}. The resource request value generator 102 aggregates Y1, Y2, 0, and 0 (such as by dividing the sum of Y1, Y2, 0, and 0 by four days) to produce an aggregate time score for the candidate resource request value represented by CTV_{Y}. The resource request value generator 102 aggregates 0, Z2, 0, and 0 (such as by dividing the sum of 0, Z2, 0, and 0 by four days) to produce an aggregate time score for the candidate resource request value represented by CTV_{Z}.

In this manner, over the four days, four aggregate time scores for four different candidate resource request values are calculated.

FIG. 4 can alternatively represent deviation scores computed over the four days for different CTV values. The aggregation of deviation scores is different than for time scores. For the deviation scores, a lack of a score for a given CTV is not assigned a zero, rather, the lack of a score is simply disregarded (dropped from consideration).

For CTV_{W}, the resource request value generator 102 aggregates W1, W2, W3, and W4 (such as by dividing the sum of W1, W2, W3, and W4 by four days) to produce an aggregate deviation score for the candidate resource request value represented by CTV_{W}. For CTV_{X}, the resource request value generator 102 aggregates X1, X2, and X3 (such as by dividing the sum of X1, X2, and X3 by three days) to produce an aggregate deviation score for the candidate resource request value represented by CTV_{X}. Note that the lack of data (represented by X 408) is disregarded, and the sum of the deviation scores is divided by one fewer day.

For CTV_{Y}, the resource request value generator 102 aggregates Y1 and Y2 (such as by dividing the sum of Y1 and Y2 by two days) to produce an aggregate deviation score for the candidate resource request value represented by CTV_{Y}. For CTV₂, the resource request value generator 102 simply uses the single deviation score Z2 as the aggregate deviation score.

In this manner, over the four days, four aggregate deviation scores for four different candidate resource request values are calculated.

The aggregate time scores and the aggregate deviation scores are then used to compute respective overall scores that are compared for selecting a resource request value from the collection of candidate resource request values.

In different examples, instead of computing scores for individual days and then aggregating those scores, the resource request value generator 102 can compute scores for other time intervals (e.g., hours, weeks, months, etc.) and then aggregate the scores for the other time intervals.

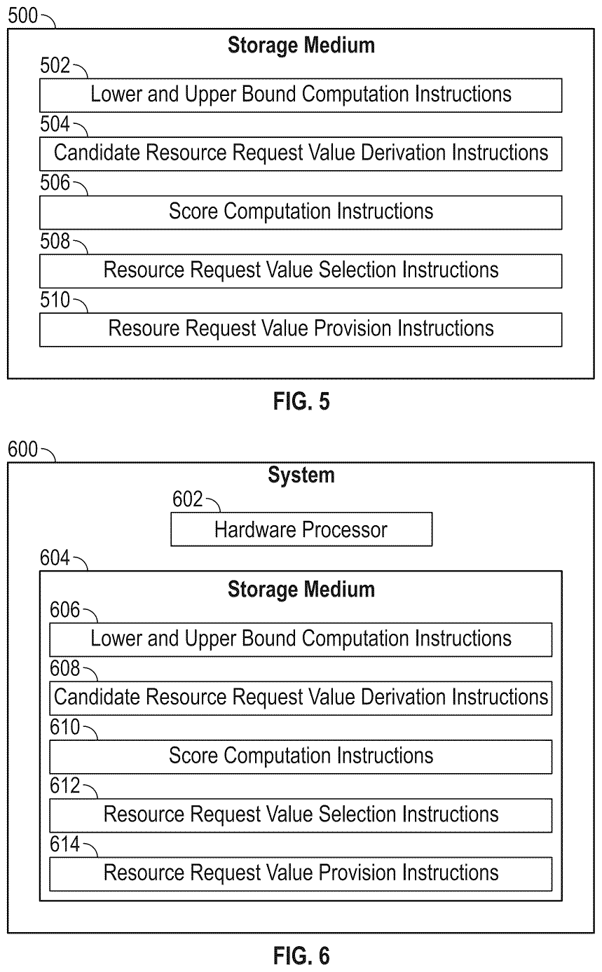

FIG. 5 is a block diagram of a non-transitory machine-readable or computer-readable storage medium 500 storing machine-readable instructions that upon execution cause a system to perform various tasks. The machine-readable instructions can be part of the resource request value generator 102 of FIG. 1, for example. The system can include one or more computers.

The machine-readable instructions include lower and upper bound computation instructions 502 to compute, based on metric information of a computing environment, a lower bound and an upper bound of resource usage in the computing environment. The metric information can include actual resource usage values indicating usage of one or more resources of the computing environment.

The machine-readable instructions include candidate resource request value derivation instructions 504 to, based on the lower bound and the upper bound, derive a plurality of candidate resource request values. The plurality of candidate resource request values can include a lower candidate resource request value set to the lower bound, an upper candidate resource request value set to the upper bound, and intermediate candidate resource request values between the lower and upper candidate resource request values.

The machine-readable instructions include score computation instructions 506 to, for each respective candidate resource request value of the plurality of candidate resource request values, compute a corresponding score representing a sufficiency of the respective candidate resource request value and resource waste associated with the respective candidate resource request value. The computing produces a plurality of scores (such as overall scores according to Eq. 1) for the plurality of candidate resource request values.

The machine-readable instructions include resource request value selection instructions 508 to, based on the plurality of scores, select a resource request value from the plurality of candidate resource request values. The selection can be based on comparing the scores for the candidate resource request values.

The machine-readable instructions include resource request value provision instructions 510 to provide the selected resource request value to a service for inclusion in a scheduling request to schedule a workload of the service in the computing environment. For example, a scheduler can schedule a workload for the service on selected compute node of multiple compute nodes in the computing environment.

In some examples, the machine-readable instructions can compute a time score representing an amount of time that a target resource usage represented by a respective candidate resource request value is less than an actual resource usage indicated by the metric information. For example, the time score is based on a quantity of times actual resource usage values in the metric information are above the target resource usage represented by the respective candidate resource request value. In a more specific example, the metric information includes the actual resource usage values across a plurality of time points, and the time score is based on a percentage of time that the actual resource usage values are above the target resource usage represented by the respective candidate resource request value. A corresponding score for the respective candidate resource request value is based on the time score.

In some examples, the time score represents the sufficiency of the respective candidate resource request value in meeting a resource demand of the service as indicated by the metric information.

In some examples, the machine-readable instructions can compute a deviation score representing an amount of resource waste associated with the respective candidate resource request value. A corresponding score for the respective candidate resource request value is based on the deviation score.

In some examples, the deviation score is based on deviations of actual resource usage values across time points indicated by the metric information from a target resource usage represented by the respective candidate resource request value.

In some examples, the deviation score is based on an aggregate (e.g., average or another type of aggregate) of the deviations of the actual resource usage values across the time points from the target resource usage represented by the respective candidate resource request value.

In some examples, the selected resource request value provides a balance between meeting a resource demand of the service and reducing waste due to a resource usage represented by the selected resource request value.

In some examples, the selected resource request value is provided to the service by writing the selected resource request value to configuration information for the service.

In some examples, the selected resource request value is for inclusion in a scheduling request from the service to a scheduler in the computing environment, the scheduler to deploy the service in a compute node of a plurality of compute nodes in the computing environment based on the selected resource request value in the scheduling request.

In some examples, the lower bound of the resource usage in the computing environment is based on an aggregate (e.g., average) of resource usage values across a plurality of time points for the service.

In some examples, the upper bound of the resource usage in the computing environment is based on a maximum of resource usage values (peak resource usage0 across a plurality of time points for the service.

In some examples, the score is computed based on computing a plurality of base scores (time scores and/or deviation scores) across a plurality of different time intervals (e.g., days such as shown in FIG. 4 or other time intervals) for the respective candidate resource request values, and for each candidate resource request value, aggregating the base scores for at least some time intervals of the plurality of different time intervals.

FIG. 6 is a block diagram of a system 600, which can be implemented using one or more computers. The system 600 includes a hardware processor 602 (or multiple hardware processors). A hardware processor can include a microprocessor, a core of a multi-core microprocessor, a microcontroller, a programmable integrated circuit, a programmable gate array, or another hardware processing circuit.

The system 600 includes a storage medium 604 storing machine-readable instructions executable on the hardware processor 602 to perform various tasks. Machine-readable instructions executable on a hardware processor can refer to the instructions executable on a single hardware processor or the instructions executable on multiple hardware processors.

The machine-readable instructions in the storage medium 604 include lower and upper bound computation instructions 606 to compute, based on metric information of service in a computing environment, a lower bound and an upper bound of resource usage in the computing environment. The lower bound is based on an aggregate (e.g., an average) of resource usage values across a plurality of time points for the service.

The machine-readable instructions in the storage medium 604 include candidate resource request value derivation instructions 608 to, based on the lower bound and the upper bound, derive a plurality of candidate resource request values.

The machine-readable instructions in the storage medium 604 include score computation instructions 610 to, for each respective candidate resource request value of the plurality of candidate resource request values, compute a corresponding score representing a sufficiency of the respective candidate resource request value and resource waste associated with the respective candidate resource request value. The computing produces a plurality of scores for the plurality of candidate resource request values.

The machine-readable instructions in the storage medium 604 include resource request value selection instructions 612 to, based on the plurality of scores, select a resource request value from the plurality of candidate resource request values.

The machine-readable instructions in the storage medium 604 include resource request value provision instructions 614 to provide the selected resource request value to the service for inclusion in a scheduling request by the service in the computing environment.

In some examples, the machine-readable instructions can compute a time score representing an amount of time that a target resource usage represented by the respective candidate resource request value is less than an actual resource usage indicated by the metric information, and compute a deviation score representing an amount of resource waste associated with the respective candidate resource request value. The machine-readable instructions can normalize the time score and the deviation score using a normalization factor. A corresponding score for the respective candidate resource request value is based on the normalized time score and deviation score.

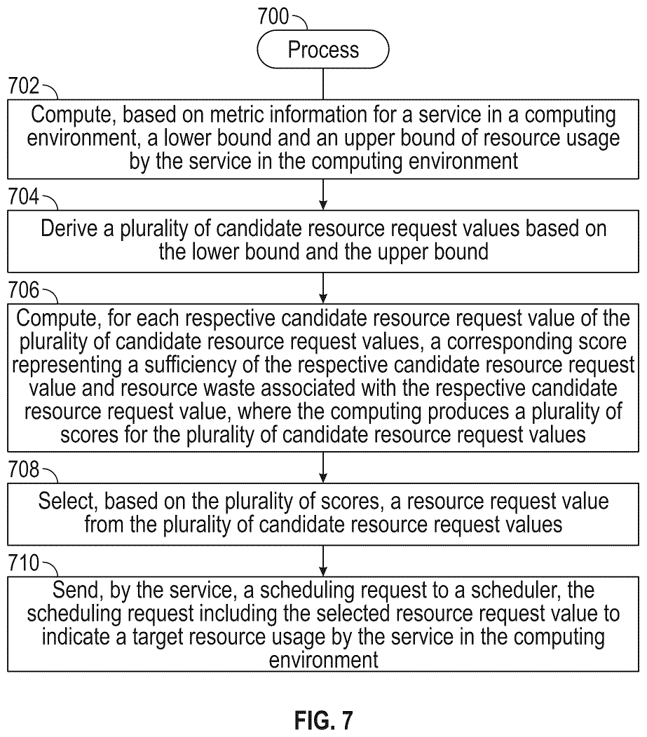

FIG. 7 is a flow diagram of a process 700, which may be performed by a system including a hardware processor. The process 700 includes computing (at 702), based on metric information for a service in a computing environment, a lower bound and an upper bound of resource usage by the service in the computing environment. The lower bound can be based on an aggregate of actual resource usage values, and the upper bound can be based on a peak resource usage.

The process 700 includes deriving (at 704) a plurality of candidate resource request values based on the lower bound and the upper bound. The plurality of candidate resource request values include a lower candidate resource request value, an upper candidate resource request value, and intermediate candidate resource request values between the lower and upper candidate resource request values.

The process 700 includes computing (at 706), for each respective candidate resource request value of the plurality of candidate resource request values, a corresponding score representing a sufficiency of the respective candidate resource request value and resource waste associated with the respective candidate resource request value. The computing produces a plurality of scores for the plurality of candidate resource request values.

The process 700 includes selecting (at 708), based on the plurality of scores, a resource request value from the plurality of candidate resource request values. The selection is based on comparing the scores.

The process 700 includes sending (at 710), by the service, a scheduling request to a scheduler, the scheduling request including the selected resource request value to indicate a target resource usage by the service in the computing environment.

In some examples, a storage device can include a disk-based storage device, a solid state drive, or another type of storage device. A memory can be implemented using one or more memory devices, such as any or some combination of the following: a dynamic or static random access memory (a DRAM or SRAM) device, an erasable and programmable read-only memory (EPROM) device, an electrically erasable and programmable read-only memory (EEPROM) device, or a flash memory device.

Various flow diagrams depict a specific order of tasks. In other examples, the tasks may be performed in a different order, some tasks may be omitted, and additional tasks may be added.

A storage medium (e.g., 500 in FIG. 5 or 604 in FIG. 6) can include any or some combination of the following: a semiconductor memory device such as a DRAM or SRAM, an EPROM, an EEPROM, or a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
compute, based on metric information of a computing environment, a lower bound and an upper bound of resource usage in the computing environment;
based on the lower bound and the upper bound, derive a plurality of candidate resource request values;
for each respective candidate resource request value of the plurality of candidate resource request values, compute a corresponding score representing a sufficiency of the respective candidate resource request value and resource waste associated with the respective candidate resource request value, the computing producing a plurality of scores for the plurality of candidate resource request values;
based on the plurality of scores, select a resource request value from the plurality of candidate resource request values; and
provide the selected resource request value to a service for inclusion in a scheduling request to schedule a workload of the service in the computing environment.

2. The non-transitory machine-readable storage medium of claim 1, wherein the instructions upon execution cause the system to:
compute a time score representing an amount of time that a target resource usage represented by the respective candidate resource request value is less than an actual resource usage indicated by the metric information,
wherein the corresponding score for the respective candidate resource request value is based on the time score.

3. The non-transitory machine-readable storage medium of claim 2, wherein the time score is based on a quantity of times actual resource usage values in the metric information are above the target resource usage represented by the respective candidate resource request value.

4. The non-transitory machine-readable storage medium of claim 3, wherein the metric information comprises the actual resource usage values across a plurality of time points, and the time score is based on a percentage of time that the actual resource usage values are above the target resource usage represented by the respective candidate resource request value.

5. The non-transitory machine-readable storage medium of claim 2, wherein the time score represents the sufficiency of the respective candidate resource request value in meeting a resource demand of the service as indicated by the metric information.

6. The non-transitory machine-readable storage medium of claim 1, wherein the instructions upon execution cause the system to:
compute a deviation score representing an amount of resource waste associated with the respective candidate resource request value,
wherein the corresponding score for the respective candidate resource request value is based on the deviation score.

7. The non-transitory machine-readable storage medium of claim 6, wherein the deviation score is based on deviations of actual resource usage values across time points indicated by the metric information from a target resource usage represented by the respective candidate resource request value.

8. The non-transitory machine-readable storage medium of claim 7, wherein the deviation score is based on an aggregate of the deviations of the actual resource usage values across the time points from the target resource usage represented by the respective candidate resource request value.

9. The non-transitory machine-readable storage medium of claim 1, wherein the selected resource request value provides a balance between meeting a resource demand of the service and reducing waste due to a resource usage represented by the selected resource request value.

10. The non-transitory machine-readable storage medium of claim 1, wherein the providing of the selected resource request value to the service comprises writing the selected resource request value to configuration information for the service.

11. The non-transitory machine-readable storage medium of claim 1, wherein the selected resource request value is for inclusion in a scheduling request from the service to a scheduler in the computing environment, the scheduler to deploy the service in a compute node of a plurality of compute nodes in the computing environment based on the selected resource request value in the scheduling request.

12. The non-transitory machine-readable storage medium of claim 1, wherein the lower bound of the resource usage in the computing environment is based on an aggregate of resource usage values across a plurality of time points for the service.

13. The non-transitory machine-readable storage medium of claim 12, wherein the aggregate of the resource usage values across the plurality of time points is an average of the resource usage values across the plurality of time points.

14. The non-transitory machine-readable storage medium of claim 1, wherein the upper bound of the resource usage in the computing environment is based on a maximum of resource usage values across a plurality of time points for the service.

15. The non-transitory machine-readable storage medium of claim 1, wherein the computing of the score comprises:
computing a plurality of base scores across a plurality of different time intervals for the respective candidate resource request values; and
for each candidate resource request value, aggregating the base scores for at least some time intervals of the plurality of different time intervals.

16. A method comprising:
computing, by a system comprising a hardware processor based on metric information for a service in a computing environment, a lower bound and an upper bound of resource usage by the service in the computing environment;
based on the lower bound and the upper bound, deriving, by the system, a plurality of candidate resource request values;
for each respective candidate resource request value of the plurality of candidate resource request values, computing, by the system, a corresponding score representing a sufficiency of the respective candidate resource request value and resource waste associated with the respective candidate resource request value, the computing producing a plurality of scores for the plurality of candidate resource request values;
based on the plurality of scores, selecting, by the system, a resource request value from the plurality of candidate resource request values; and
sending, by the service, a scheduling request to a scheduler, the scheduling request comprising the selected resource request value to indicate a target resource usage by the service in the computing environment.

17. The method of claim 16, wherein the lower bound of the resource usage in the computing environment is based on an average of resource usage values across a plurality of time points for the service, and the upper bound of the resource usage in the computing environment is based on a maximum of the resource usage values across the plurality of time points for the service.

18. The method of claim 16, further comprising:
computing a time score representing an amount of time that a target resource usage represented by the respective candidate resource request value is less than an actual resource usage indicated by the metric information;
computing a deviation score representing an amount of resource waste associated with the respective candidate resource request value,
wherein the corresponding score for the respective candidate resource request value is based on the time score and the deviation score.

19. A system comprising:
a hardware processor; and
a non-transitory storage medium storing instructions executable on the hardware processor to:
compute, based on metric information of service in a computing environment, a lower bound and an upper bound of resource usage in the computing environment, wherein the lower bound is based on an aggregate of resource usage values across a plurality of time points for the service;
based on the lower bound and the upper bound, derive a plurality of candidate resource request values;
for each respective candidate resource request value of the plurality of candidate resource request values, compute a corresponding score representing a sufficiency of the respective candidate resource request value and resource waste associated with the respective candidate resource request value, the computing producing a plurality of scores for the plurality of candidate resource request values;
based on the plurality of scores, select a resource request value from the plurality of candidate resource request values; and
provide the selected resource request value to the service for inclusion in a scheduling request by the service in the computing environment.

20. The system of claim 19, wherein the instructions are executable on the hardware processor to:
compute a time score representing an amount of time that a target resource usage represented by the respective candidate resource request value is less than an actual resource usage indicated by the metric information;
compute a deviation score representing an amount of resource waste associated with the respective candidate resource request value,
normalize the time score and the deviation score using a normalization factor,
wherein the corresponding score for the respective candidate resource request value is based on the normalized time score and deviation score.
